(19) United States
(12) Patent Application Publication
(10) Pub. No.: US 2015/0350304 A1
(43) Pub. Date: Dec. 3, 2015

(54) SYSTEMS AND METHODS FOR IMPLEMENTING A PLATFORM FOR PROCESSING STREAMS OF INFORMATION

(71) Applicant: THE INTELLISIS CORPORATION, San Diego, CA (US)

(72) Inventor: Douglas A. Palmer, San Diego, CA (US)

(73) Assignee: THE INTELLISIS CORPORATION, San Diego, CA (US)

(21) Appl. No.: 14/290,876

(22) Filed: May 29, 2014

(51) Int. Cl. H04L 29/08; H04L 29/06

(52) U.S. Cl. CPC H04L 67/10; H04L 65/601

(57) ABSTRACT

Systems and methods to implement a platform for processing streams of information, in particular quantification information such as, e.g., real-time sensor data, allow users to define algorithms that are evaluated and re-evaluated continuously as new information becomes available. Revenue received from users and/or other entities that are operating within the platform (or in conjunction with the platform) may be shared with the providers and/or publishers of the streams of information.

### FIELD

The disclosure relates to systems and methods for implementing a platform for processing streams of information and, in particular, sharing revenue with publishers of the streams of information.

### BACKGROUND

Users can access online services, applications, and web pages via the internet, for example through client computing platforms. Presenting and/or providing information via the internet, in particular quantification information such as, e.g., sensor output signals, is known. Online services, web pages, and/or applications may include content based on quantification information. Using a browser software application to present a web page and/or other information on a client computing platform is known.

### SUMMARY

One aspect of the disclosure relates to systems configured to implement a platform for processing streams of information. The system may facilitate communication between users and providers of computer applications, providers of streams of information, providers of advertisements, and/or other entities, which may collectively be referred to as content providers. The system may facilitate communication between different content providers. The system and/or any entities that communicate with the system may be deployed using a (public) network and/or commercial web services. The system may facilitate communication between content providers and users, for example through client computing platforms associated with users. The system may include physical storage, an interface, a storage component, a set of stream input components, one or more servers, one or more physical processors, and/or other components.

Streams of information may include streams of quantification information, streams of real-time information, streams of sensor-generated output signals, streams of financial information, and/or other streams of information. As used herein, quantification information may be numerical information that quantifies something, including but not limited to financial information, metrological information, geological information, historical information, economic information, logistical information, commercial information, and/or other numerical information. As used herein, the term “real-time information” may refer to information that reflects the current value, state, and/or condition of a quantifiable object, property, characteristic and/or attribute. A delay between the generation of real-time information and its availability for processing within the system is not construed to negate or reduce the property of being “real-time” information. Streams of information may include and/or be made up of series of numerical values.

Providers of streams of information may include owners of streams of information, publishers of streams of information, owners of systems and/or equipment that produce streams of information, aggregators of streams of information, and/or other providers, including (financial) stakeholders and/or business associates of providers of streams of information. Providers of streams of information may include providers that format, process, organize, and/or otherwise convert information such that the system can use the resulting information as described herein.

For example, a farmer may provide streams of information regarding various humidity and/or temperature sensors on his land. Streams of information may provide and/or produce new numerical values at a constant rate, a varying rate, a minimum rate, a maximum rate, and/or other rates or combinations thereof. For example, the rate of a stream of temperature information for a particular temperature sensor may correspond to the rate with which the particular temperature sensor generates output signals conveying numerical values that indicate temperature information. On behalf of a county or state, streams of information may be gathered or provided that are received from multiple farmers within the county or state. A sensor manufacturer and/or operator may gather and provide streams of information received from multiple customers that use their humidity and/or temperature sensors. An aggregator may gather and provide streams of information received from one or more of individual farmers, individual counties or states, individual sensor manufacturers, individual aggregators, and/or other providers. Aggregators may be referred to as distributors.

Stream input components may be configured to receive streams of information, e.g. quantification information made up of series of numerical values, from content providers. In some embodiments, stream input components may be configured to receive streams of quantification information that include real-time information.

Providers of computer applications may create and/or provide application definitions that define computer applications. Computer applications may be configured to execute instructions as defined by the corresponding application definitions. As used herein, a provider of a computer application may also be referred to as an application developer and/or application publisher. In some embodiments, individual computer applications may be associated with corresponding individual financial stakeholders. In some embodiments, individual application definitions may be associated with corresponding individual financial stakeholders.

As used herein, any association involving one or more of a stream of information, a providers of such a stream, a content provider, a stakeholder, a computer application, an application definition, a user, and/or another entity that interacts with any part of the system, may be a one-to-one association, a one-to-many association, a many-to-one association, and/or a many-to-many association or N-to-M association (note that N and M may be different numbers greater than 1). For example, a particular stream input component may be associated with multiple computer applications. For example, a particular computer application may be associated with multiple client computing platforms for delivery of an output stream of information. These examples are not intended to be limiting in any way.

The interface may be configured to receive application definitions from application developers. The storage component may be configured to store received application definitions in physical storage. Physical storage may be physically located in one location, or may be distributed in different locations, including but not limited to “the cloud”.

Computer applications may be configured, in accordance with corresponding application definitions, to execute instructions to, by way of non-limiting example, obtain numerical values in streams of information, use the obtained numerical values in operations and/or calculations to generate output streams of application output, initiate delivery of the output streams to client computer platforms, and/or other tasks and/or features. Computer applications may include computer program components configured to execute instructions. The computer program components may include one or more of an input value component, a processing component, a delivery component, and/or other components.

Client computing platforms may include one or more processors configured to execute computer program components. The computer program components may be configured to enable a user associated with a client computing platform to interact with the system, any component thereof, other client computing platforms, and/or provide other functionality attributed herein to client computing platforms. By way of non-limiting example, client computing platforms may include one or more of a desktop computer, a laptop computer, a handheld computer, a NetBook, a Smartphone, a tablet, a mobile computing platform, a gaming console, a television, a device for streaming internet media, and/or other computing platforms.

The one or more servers included in the system may include one or more processors configured to execute computer program components.

Interaction with the system may be accomplished through web pages, (mobile) applications, apps, stand-alone applications, desktop applications, and/or other types of software applications capable of interacting with a network, for example the internet. As used herein, content provided through any type of software application capable of interacting with a network may be referred to as a web page (including, but not limited to, mobile applications or “apps”).

Web pages may be rendered, interpreted, and/or displayed for presentation using a computing platform, such as a client computing platform. As used herein, displaying information through a mobile application—or app—is included in the term presentation. Presentation of web pages may be supported through a display, screen, monitor of the computing platform, and/or projection by the computing platform. Web pages may be accessible from a local computing platform (e.g. not currently connected to the internet) and/or hosted by a remote web server (e.g. connected to the internet and/or one or more other networks). Web pages may be accessed through a browser software application being executed on a computing platform.

As used herein, mobile applications may be included in the term browser software application. Web pages may be static (e.g. stored using electronic storage that is accessible by a web server), dynamic (e.g. constructed when requested), and/or a combination of both. The browser software application may be configured to render, interpret, and/or display one or more web pages for presentation using a computing platform. The digital content included in a web page may have been provided by one or more content providers. A set of linked and/or organized web pages may form a website. A website may include a set of related and/or linked web pages hosted on one or more web servers and accessible via a network, e.g. the internet. Websites and/or web pages may be accessible through an address called a uniform resource locator (URL).

Users may subscribe to streams of information, including, but not limited to, output streams of application output generated by computer applications. Delivery of output streams to client computer platforms may be performed in accordance with user subscriptions. User subscriptions may define relations between individual computer applications and one or more users.

By virtue of the systems and methods described in this disclosure, streams of information may be processed and delivered to users. In some embodiments, users may use delivered streams of information in a type of spreadsheet application that updates and/or re-evaluates, e.g. as new numerical values are delivered. Changes in one or more elements of a spreadsheet application may in turn (automatically without human intervention) cause changes in other elements of the spreadsheet application. Elements in such a spreadsheet application may for example be displayed in a manner analogous to a strip-chart recorder.

In some embodiments, streams of information may be delivered in exchange for revenue from the users. In some embodiments, revenue may be shared with application developers, financial stakeholders, content providers, and/or others. In some embodiments, receiving, sharing, and/or distributing of revenue may be performed by a compensation component. Results and/or determinations by the compensation component (e.g. pertaining to receiving, sharing, and/or distributing of revenue) may be combined in reports, bills, messages, information presented for display, and/or other ways to combine and/or present results.

The compensation component may be configured to determine, based on information from other components, a fair compensation for the providers of streams of information. The compensation component may be configured to determine compensation for content providers and/or providers of digital content that meets specified criteria. For example, the determined compensation may be for a set of content providers of information pertaining to financial information that has been presented to a particular set of users.

The compensation component may be configured to produce bills, invoices, payments, and/or other financial documents and/or messages to initiate the collection of payments and/or the disbursement of payments based on the determined compensations.

In some embodiments, the system may be configured to deliver (online) advertising to users in conjunction with delivery of streams of information. In some embodiments, the system may be configured to sell and/or auction (online) advertising to advertisers. Revenue from advertising may be shared with application developers, financial stakeholders, content providers, sellers of advertisements, and/or others. In some embodiments, the system may include one or more ad servers. An ad server may host and/or provide digital content, usually of a commercial nature, to be presented for display on client computing platforms. The presentation of digital content may occur in conjunction with the presentation of one or more streams of information, digital media files, web pages, and/or other digital content. The digital content may include one or more of advertisements, coupons, offers, sales information, branding information, and/or other information of a commercial nature. These types of information of a commercial nature may jointly be referred to as “ads” or “advertisements” throughout this disclosure. In some embodiments, the system may include one or more demand-side platforms configured to provide a market, auction-house, and/or exchange pertaining to advertising.

These and other objects, features, and characteristics of the servers, systems and/or methods disclosed herein, as well as the methods of operation and functions of the related elements of structure and the combination of parts and economies of manufacture, will become more apparent upon consideration of the following description and the appended claims with reference to the accompanying figures, all of which form a part of this specification, wherein like reference numerals designate corresponding parts in the various figures. It is to be expressly understood, however, that the figures are for the purpose of illustration and description only and are not intended as a definition of any limits. As used in the specification and in the claims, the singular form of “a”, “an”, and “the” include plural referents unless the context clearly dictates otherwise. As used in the specification and in the claims, in a list of items that includes the separator “and/or”, combinations of those items, insofar as practically possible, are envisioned as embodiments.

### BRIEF DESCRIPTION OF THE DRAWINGS

FIGS. 1 and 2 illustrate systems configured to implement a platform for processing streams of information in accordance with one or more implementations.

FIG. 3 illustrates a method for implementing a platform for processing streams of information in accordance with one or more implementations.

### DETAILED DESCRIPTION

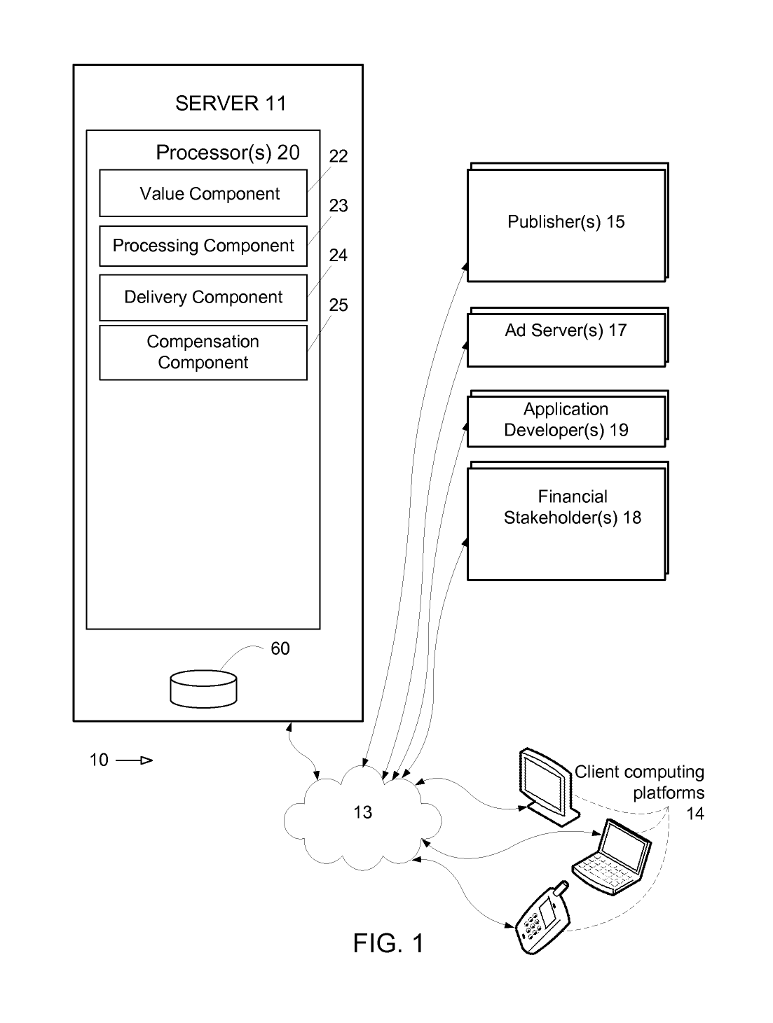

FIG. 1 illustrates a system 10 configured to implement a platform for processing streams of information. System 10 may facilitate communication between users and content providers, as well as between content providers. The content providers may include, by way of non-limiting example, one or more stream providers 15 (interchangeably referred to as publishers 15), one or more application developers 19, one or more ad servers 17, one or more financial stakeholders 18, and/or other participants. Users may interact with system 10 through client computing platforms 14. Interaction may be supported by one or more networks 13, including but not limited to the internet.

Streams of information may include, by way of non-limiting example, information pertaining to financial data, stock picks, movers in financial trading, financial forecasts, exchange rates, and/or other types of financial information. Streams of information may include information gathered from power systems and/or power consumption. Streams of information may include information gathered from (water) reservoirs, water (provision) systems, irrigation systems, water treatment systems, sewage systems, and/or other water-related systems. Streams of information may include information gathered from ports, airports, rail terminals, traffic patterns, traffic delays, vehicular traffic information, network traffic, network congestion, internet traffic, and/or other systems for moving people, goods, and/or services. Streams of information may include information gathered from weather activity, climate monitoring, temperature and/or humidity measurements, volcanic activity, earthquake monitoring, and/or other metrological information. Streams of information may include information gather through sampling and/or polling viewers, listeners, participants, and/or the public at large. Streams of information may include information related to sound feeds, applause measurements, etc.

By virtue of the systems and methods described in this disclosure, users may construct algorithms using streams of information and analyze and/or discover trends and/or correlations between different streams of information.

Individual streams of information may be associated with a description of the nature of the individual streams of information. Such a description may be implemented using a markup language, such as Extensible Markup Language (XML). Usage of descriptions may help users find particular streams of information from a large variety of available streams of information. For example, the description of a stream of information may include information about the origin, geographical location, owner, unit, upper and/or lower limits of a stream of information, and/or other pertinent characteristics of a stream of information that may be helpful to use individual numerical values included in the stream of information. For example, a stream of information may represent the current stock price of a particular stock. The unit may indicate in which currency this particular stock is traded. In some embodiments, the description of a stream of information may indicate a rate at which a stream is updated.

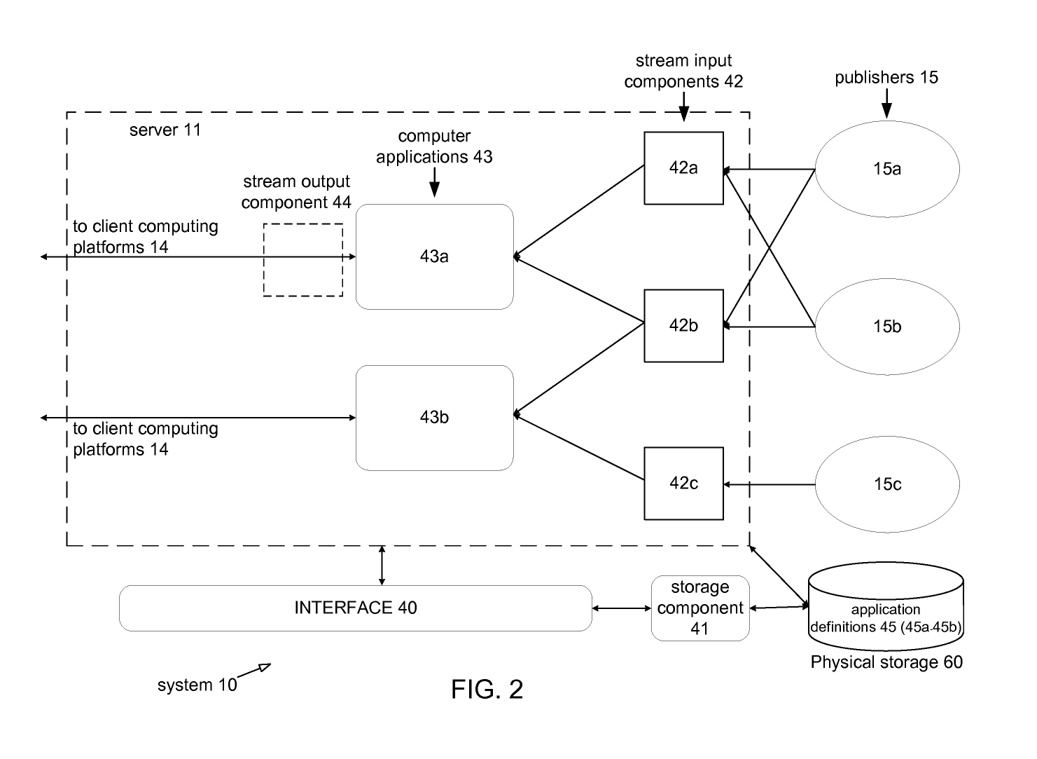

As depicted in FIGS. 1 and 2, system 10 may include one or more servers 11, one or more processors 20, physical storage 60, an interface 40, a storage component 41, a set of stream input components 42 (e.g. including stream input components 42a-42b-42c), one or more computer applications 43 (e.g. including computer application 43a and 43b), one or more application definitions 45 (e.g. application definitions 45a and 45b), and/or other components.

Streams of information, e.g. real-time quantification information, may be provided to system 10 by one or more publishers 15 (e.g. one or more of publishers 15a-15b-15c depicted in FIG. 2). Streams of information may be received by one or more stream input components 42. Streams of information may be made up of series of numerical values. In some embodiments, the numerical values are generated by sensors, or based on output signals generated by sensors. As depicted in FIG. 2, publisher 15a provides streams of information to stream input component 42a and stream input component 42b, publisher 15b provides streams of information to stream input component 42a and stream input component 42b, and publisher 15c provides a stream of information to stream input component 42c.

In some embodiments, publisher 15 may provide interactive access to a stored stream of information, including but not limited to a database. For example, a publisher may be queried for particular information and, in response, provide the queried information. For example, a database of recorded metrological measurements (or historical stock prices, or other information) may be queried for particular historical dates. The exemplary use of time or dates to organize stored information is intended to be exemplary, and not in any way limiting. In some embodiments, through queryable stored streams of information, users may be able to examine whether their constructed algorithms appear to have predicted power. For example, users may be able to examine whether some particular combination of crop prices, weather patterns, and geo-political developments appear to be predictive (and/or appear to indicate the onset of a trend) for a particular stock or bond price.

Application definitions 45 may be provided by application developers 19 (shown in FIG. 1), e.g. received by interface 40. Physical storage 60 may be configured to store application definitions 45. Application definitions 45 may define and correspond to computer applications 43. For example, application definition 45a may define and correspond to computer application 43a, and application definition 45b may define and correspond to computer application 43b, and so on and so forth. Storage component 41 may be configured to store application definitions 45, received through interface 40, in physical storage 60. Computer applications 43 may be configured, in accordance with corresponding application definitions 45, to execute instructions to, by way of non-limiting example, obtain numerical values in streams of information, use the obtained numerical values in operations and/or calculations to generate output streams of application output, initiate delivery of the output streams to client computer platforms 14, and/or other tasks and/or features.

One or more processors 20 (interchangeably referred to herein as processor 20) may be configured to execute computer applications 43 and/or computer program components. The computer program components may include a value component 22, a processing component 23, a delivery component 24, a compensation component 25, and/or other components.

Value component 22 may be configured to obtain numerical values in streams of information, e.g. streams of information received by one or more stream input components 42. In some embodiments, value component 22 may be configured to obtain numerical values from streams of information as specified by application definitions. For example, computer application 43b, as defined by application definition 45b, may be configured to obtain numerical values in streams of information received from stream input components 42a-42b-42c, which in turn receive streams of information from publishers 15a-15b-15c.

Processing component 23 may be configured to use the obtained numerical values (e.g. from value component 22) in calculations and/or operations defined by application definitions 45. Processing component 23 may be configured to generate output streams of application output based on the obtained numerical values. For example, for computer application 43b, processing component 23 may be configured to determine the average of the latest values from stream input component 42b and stream input component 42b. The determined average may be re-evaluated for a new obtained numerical value. The determined averages may form a series of numerical values that form an output stream of information. By combining numerical values from multiple streams of information, computer applications 43 may be configured to implement algorithms, e.g. financial trading algorithms.

Delivery component 24 may be configured to initiate delivery of output streams (e.g. generated by computer applications 43) to one or more client computing platforms 14. In some embodiments, output streams may be distributed through one or more stream output components 44. Delivery by delivery component 24 and/or one or more stream output components 44 may be in accordance with user subscriptions. For example, a particular user may subscribe to a particular trading algorithm that is implemented by computer application 43b. In some embodiments, subscriptions may be stored in a subscription database, e.g. stored in physical storage 60.

In some embodiments, subscribers may subscribe to streams of information (e.g. output streams generated by computer applications 43) in order to track news activity, energy usage, utility usage, traffic control, inventory control (e.g. as part of sales and/or marketing management), machine control, factory control, homeland security applications, and/or other types of industrial control. For example, certain patterns in internet traffic may anticipate a need for flu vaccinations. For example, certain patterns in weather may anticipate certain price fluctuations in commodities. For example, certain patterns in sales in one particular area/location may anticipate demand for other products and/or demand in another area/location. For example, an increase in certain types of news stories or current events may cause certain types of stocks to react/respond. For example, a shortage in certain types of materials and/or intermediate products may cause a price fluctuation for (consumer) products that require such materials and/or intermediate products.

In some embodiments, delivery by delivery component 24 may be initiated in exchange for revenue from users. Users may for example pay for a computer application, for access to the output stream of a computer application (e.g. a subscription for a predetermined period, such as a monthly subscription), for processing of streams of information, through advertising, and/or by other ways to pay. For example, ads may be delivered in conjunction with an output stream. In some embodiments, ads may be removable from a computer application in exchange for a payment.

In some embodiments, streams of information may have multiple levels of quality and/or delay, such that a free version of a particular stream of information may be replaced for a corresponding version of that particular stream of information that is better and/or faster in exchange for a payment. For example, a stream of information that represents stock prices may have varying amounts of delay, from 1 ms, to 10 ms, to 100 ms, to 1 s, and so on. A smaller delay and/or faster delivery may correspond to a more expensive (i.e. a more highly valued) stream of information, at least for some types of users performing particular types of trades. In some embodiments, different entities participating in system 10 may receive revenue from users and/or advertisers (e.g. through ad servers 17). Additional mechanisms to monetize a platform for processing streams of information, as well as combinations thereof, are considered within the scope of this disclosure.

In some embodiments, system 10 may include and/or interact with one or more demand-side platforms. A demand-side platform may be configured to provide a market, auction-house, and/or exchange pertaining to advertising. In some embodiments, a demand-side platform provides ad exchange accounts and/or data exchange accounts for advertisers. In some embodiments, a demand-side platform enables (real-time) bidding for displaying online ads. In some embodiments, a demand-side platform may issue and/or transmit a request for and/or invitation to acquire information. The information may pertain to particular users, publishers 15, stream input components 42, computer applications 43, and/or other components of system 10. In some embodiments, the request may be for a set of user identifiers that correspond to users that satisfy one or more criteria. The criteria may include one or more of demographic criteria, usage criteria, computing device criteria, and/or other criteria. Demographic criteria may include statistical characteristics of the users themselves. Usage criteria may include information about usage by the users of one or more websites, applications, platforms, and/or other systems. For example, advertisers may bid, e.g. though a demand-side platform, to present advertisements to users of a particular computer application 43, a particular stream input component 42, a particular publisher 15, a particular stream of information, a particular (type of) sensor used to generate a stream of information, and/or other components and/or entities of system 10. By virtue of the system described herein, advertisers may provide targeted advertising to users. For example, users that track the price of gold may be interested in advertising related to commercial transactions involving and/or related to gold.

In some embodiments, application definitions 45 and/or computer applications 43 may be associated with one or more financial stakeholders 18. In some embodiments, part or all of the revenue received in exchange for an output stream may be received by one or more financial stakeholders 18.

In some embodiments, system 10 includes a compensation component 25. Compensation component 25 may be configured to receive remunerations from one or more financial stakeholders 18. In some embodiments, received remunerations may be based on received revenue from users. In some embodiments, compensation component 25 may be configured to determine compensations for publishers 15 and/or other content providers. In some embodiments, determined compensations may be based on remunerations received from one or more financial stakeholders 18 and/or one or more application developers 19.

In some embodiments, compensation component 25 may be configured to combined results and/or determinations in reports, bills, messages, information presented for display, and/or other ways to combine and/or present results.

Compensation component 25 may be configured to determine, based on information from other components, a fair compensation for one or more content providers. The compensation may be based on revenue for initiating delivery of an output stream of application output, delivery of ads, and/or for other tasks.

Compensation component 25 may be configured to produce bills, invoices, payments, and/or other financial documents and/or messages to initiate the collection of payments and/or the disbursement of payments based on the determined (proposed) compensations. Compensation component 25 may be configured to produce, generate, and/or transmit financial documents to initiate the distribution of payments based on the determined intended compensations for, e.g., content providers.

In some implementations, one or more computer applications 43 may be implemented using processing engines that are the same as or similar to the neural processing (e.g. “neural processing engine 220”) described in U.S. patent application Ser. No. 13/560,890, filed Jul. 27, 2012, and entitled “NEURAL PROCESSING ENGINE AND ARCHITECTURE USING THE SAME”, which is hereby incorporated by references in its entirety into the present disclosure. This application may be referred to as “the '890 application” herein. Additional details related to the features and functionality of processing engines may be found in the '890 application.

For example, processing engines the same or similar to those described in the '890 application may be suitable for packet-based processing. Individual packets may include one or more numerical values that form a part of a series and/or sequence of numerical values which, in turn, make up a stream of information. As new numerical values of a stream of information are generated and/or otherwise made available, one or more corresponding new packets may be generated, transferred, and/or processed by a processing engine.

An individual processing engine may include one or more of a non-transitive storage, a register file, a micro-sequencer, an arithmetic logic unit, and/or other components. The non-transitive storage may be configured to store instruction code implementing one or more sets of instructions. The register file may be configured to electronically and non-transitively store information. The register file may include one or more of a first packet space into which packets of information have been transferred, and a second packet space into which generated packs are assembled prior to transfer to other components within a system that includes multiple processing engines. The micro-sequencer may be configured to determine instructions to be executed based on one or more operator codes included in a packet. The arithmetic logic unit may be configured to perform the determined instructions on operands included in a packet such that output values are generated. The micro-sequencer may be further configured to assemble output packets from generated output values, e.g. in the second packet space.

One or more processors 20 may be configured to provide information processing capabilities in system 10 and/or server 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 1 as a single entity, this is for illustrative purposes only. In some embodiments, processor 20 may include a plurality of processing units. These processing units may be physically located within the same device, or processor 20 may represent processing functionality of a plurality of devices operating in coordination (e.g., “in the cloud”, and/or other virtualized processing solutions).

It should be appreciated that although components 22-25, are illustrated in FIG. 1 as being co-located within a single processing unit, in implementations in which processor 20 includes multiple processing units, one or more of components 22-25 may be located remotely from the other components. The description of the functionality provided by the different components 22-25 described herein is for illustrative purposes, and is not intended to be limiting, as any of components 22-25 may provide more or less functionality than is described. For example, one or more of components 22-25 may be eliminated, and some or all of its functionality may be provided by other ones of components 22-25. As another example, processor 20 may be configured to execute one or more additional components that may perform some or all of the functionality attributed herein to one of components 22-25.

Physical storage 60 of system 10 in FIG. 1 may comprise electronic storage media that stores information. The electronic storage media of physical storage 60 may include one or both of system storage that is provided integrally (i.e., substantially non-removable) with server 11 and/or removable storage that is removably connectable to server 11 via, for example, a port (e.g., a USB port, a FireWire™ port, etc.) or a drive (e.g., a disk drive, etc.). Physical storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Physical storage 60 may include virtual storage resources, such as storage resources provided via a cloud and/or a virtual private network. Physical storage 60 may store software algorithms, information determined by processor 20, information received via client computing platforms 14, and/or other information that enable server 11 and system 10 to function properly. Physical storage 60 may be separate components within system 10, or physical storage 60 may be provided integrally with one or more other components of system 10 (e.g., processor 20).

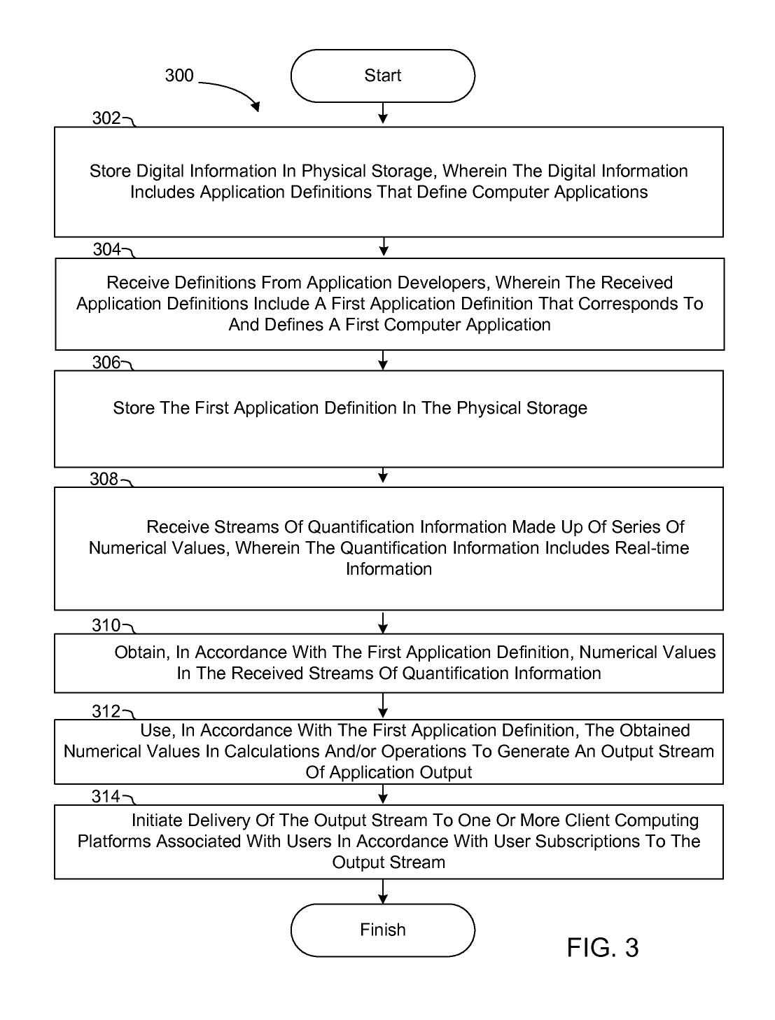

FIG. 3 illustrates a method 300 for implementing a platform for processing streams of information. The operations of method 300 presented herein are intended to be illustrative. In some embodiments, method 300 may be accomplished with one or more additional operations not described, and/or without one or more of the operations discussed. Additionally, the order in which the operations of method 300 are illustrated in FIG. 3 and described herein is not intended to be limiting.

At an operation 302, electronic and/or digital information is stored in the physical storage. The electronic and/or digital information includes application definitions that define computer applications. In some embodiments, operation 302 is performed by a physical storage the same as or similar to physical storage 60 (shown in FIG. 1 and described herein).

At an operation 304, application definitions are received from application developers. The received application definitions include a first application definition that corresponds to and defines a first computer application. In some embodiments, operation 304 is performed by an interface the same as or similar to interface 40 (shown in FIG. 2 and described herein).

At an operation 306, the first application definition is stored in the physical storage. In some embodiments, operation 306 is performed by a storage component the same as or similar to storage component 41 (shown in FIG. 2 and described herein). In some embodiments, the physical storage may be the same as or similar to physical storage 60 (shown in FIG. 1 and described herein).

At an operation 308, streams of quantification information are received, the streams being made up of series of numerical values. The quantification information may include real-time information. In some embodiments, operation 308 is performed by a stream input component the same as or similar to stream input component 42 (shown in FIG. 2 and described herein). In some embodiments, stream input components may receive numerical values from (a network of) sensors.

At an operation 310, series of numerical values are obtained, in accordance with the first application definition, in the received streams of quantification information. In some embodiments, operation 310 is performed by a value component the same as or similar to value component 22 (shown in FIG. 2 and described herein).

At an operation 312, the obtained numerical values are used, in accordance with the first application definition, in calculations and/or operations to generate an output stream of application output. In some embodiments, operation 312 is performed by a processing component the same as or similar to processing component 23 (shown in FIG. 2 and described herein).

At an operation 314, delivery of the output stream is initiated to one or more client computing platforms associated with users in accordance with user subscriptions to the output stream. In some embodiments, operation 314 is performed by a delivery component the same as or similar to delivery component 24 (shown in FIG. 2 and described herein). In some embodiments, operation 314 may be performed in exchange for revenue, e.g. money, from one or more users associated with the one or more client computing platforms that receive delivery of the output stream.

In some embodiments, method 300 may be implemented in one or more processing devices (e.g., a server, a digital processor, an analog processor, a digital circuit designed to process information, an analog circuit designed to process information, and/or other mechanisms for electronically processing information). The one or more processing devices may include one or more devices executing some or all of the operations of method 300 in response to instructions stored electronically on an electronic and/or physical storage medium. The one or more processing devices may include one or more devices configured through hardware, firmware, and/or software to be specifically designed for execution of one or more of the operations of method 300.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation (or claim) can be combined with one or more features of any other implementation (or claim).

What is claimed is:

1. A system configured to implement a platform for processing streams of quantification information, the system comprising:
physical storage configured to store digital information, wherein the digital information includes application definitions that define computer applications;
an interface configured to receive application definitions from application developers, wherein the received application definitions include a first application definition that corresponds to and defines a first computer application;
a storage component configured to store received application definitions in the physical storage such that the storage component is configured to store the first application definition in the physical storage;
a set of stream input components configured to receive streams of quantification information made up of series of numerical values, wherein the quantification information includes real-time information; and
one or more physical processors configured to execute the application definitions to implement the computer applications defined by the application definitions, wherein the first application definition specifies an association with a first set of stream input components, wherein the first computer application is configured, in accordance with the first application definition, to execute instructions to:
obtain numerical values in streams of quantification information received by the first set of stream input components as specified by the first application definition,
use the obtained numerical values in calculations/operations defined by the first application definition to generate an output stream of application output,
initiate delivery of the output stream to one or more client computing platforms associated with users in accordance with user subscriptions to the output stream.

2. The system of claim 1, wherein individual application definitions include one or more streams of quantification information.

3. The system of claim 1, wherein user subscriptions to output streams generated by computer applications define relations between individual computer applications and one or more users.

4. The system of claim 1, wherein the storage component is further configured to store a database that implements relations between individual computer applications and individual users.

5. The system of claim 1, wherein the streams of quantification information are provided by providers.

6. The system of claim 1, wherein delivery of the output stream is initiated in exchange for revenue from one or more of the users associated with the one or more client computing platforms that received delivery of the output stream.

7. The system of claim 1, wherein delivery of the output stream is accompanied by a second delivery to the one or more client computing platforms associated with the users in accordance with user subscriptions to the output stream, wherein the second delivery includes one or more advertisements provided by an advertisement provider, wherein the second delivery is performed in exchange for revenue from the advertisement provider.

8. The system of claim 6 or claim 7, wherein individual received application definitions are associated with corresponding individual financial stakeholders such that the first application definition is associated with a first financial stakeholder, wherein at least part of the revenue is received by the first financial stakeholder.

9. The system of claim 8, further comprising:
a compensation component configured to receive remunerations from individual financial stakeholders such that the compensation component is configured to receive a first remuneration from the first financial stakeholder, wherein the first remuneration is based on at least part of the received revenue by the first financial stakeholder.

10. The system of claim 9, wherein the compensation component is further configured to determine compensations for providers of the streams of quantification information, wherein individual compensations are based on the received remunerations.

11. A computer-implemented method to implement a platform for processing streams of quantification information, the method being implemented in a computer system that includes one or more physical processors and physical storage, the method comprising:
storing digital information in the physical storage, wherein the digital information includes application definitions that define computer applications;
receiving definitions from application developers, wherein the received application definitions include a first application definition that corresponds to and defines a first computer application;
storing the first application definition in the physical storage;
receiving streams of quantification information made up of series of numerical values, wherein the quantification information includes real-time information;
obtaining, in accordance with the first application definition, numerical values in the received streams of quantification information;
using, in accordance with the first application definition, the obtained numerical values in calculations/operations to generate an output stream of application output; and
initiating delivery of the output stream to one or more client computing platforms associated with users in accordance with user subscriptions to the output stream.

12. The method of claim 11, wherein individual application definitions include one or more streams of quantification information.

13. The method of claim 11, wherein user subscriptions to output streams generated by computer applications define relations between individual computer applications and one or more users.

14. The method of claim 11, further comprising:
storing a database in the physical storage, wherein the database implements relations between individual computer applications and individual users.

15. The method of claim 11, wherein the streams of quantification information are provided by providers.

16. The method of claim 10, wherein initiating delivery of the output stream is performed in exchange for revenue from one or more of the users associated with the one or more client computing platforms that received delivery of the output stream.

17. The method of claim 10, wherein delivery of the output stream is accompanied by a second delivery to the one or more client computing platforms associated with the users in accordance with user subscriptions to the output stream, wherein the second delivery includes advertisement provided by an advertisement provider, wherein the second delivery is performed in exchange for revenue from the advertisement provider.

18. The method of claim 16 or claim 17, wherein individual received application definitions are associated with corresponding individual financial stakeholders such that the first application definition is associated with a first financial stakeholder, the method further comprising:
receiving, by the first financial stakeholder, at least part of the revenue.

19. The method of claim 18, further comprising:
receiving a first remuneration from the first financial stakeholder, wherein the first remuneration is based on at least part of the received revenue by the first financial stakeholder.

20. The method of claim 19, wherein the streams of quantification information are provided by providers, the method further comprising:
determining compensations for the providers of the streams of quantification information, wherein individual compensations are based on the received remunerations.
